(19) United States
(12) Patent Application Publication
(10) Pub. No.: US 2021/0180558 A1
(43) Pub. Date: Jun. 17, 2021

(54) UNDERWATER INSTALLATION-TYPE WATER-FLOW POWER GENERATION SYSTEM

(71) Applicant: Japan System Planning Co., Ltd., Tokyo (JP)

(72) Inventor: Katsuyuki KUMANO, Tokyo (JP)

(73) Assignee: Japan System Planning Co., Ltd., Tokyo (JP)

(21) Appl. No.: 17/107,492

(22) Filed: Nov. 30, 2020

(30) Foreign Application Priority Data
Dec. 12, 2019 (JP) 2019-224628

(51) Int. Cl. F03B 13/26; F03B 13/10

(52) U.S. Cl. CPC F03B 13/264; F03B 13/10; F03B 17/063; F05B 2240/95; F05B 2240/13

(57) ABSTRACT

The present invention provides an underwater installation-type water-flow power generation system constituted such that, even if a plurality of underwater installation-type water-flow power generation units is to be installed in a deep water area, a collision between each of the plurality of underwater installation-type water-flow power generation units can be prevented, and each of the underwater installation-type water-flow power generation units can be installed under the sea simply, rapidly, and safely in the same state as the installation under the shallow sea a large power generation output can be obtained efficiently and stably by using an ocean current or a water flow which is natural energy.

### TECHNICAL FIELD

The present invention relates to an underwater installation-type water-flow power generation system and more particularly to an underwater installation-type water-flow power generation system constituted such that, even if a plurality of underwater installation-type water-flow power generation units each having a simple and inexpensive installation constitution is to be installed in a deep water area, mutual tangling of each of an upper pulling tool and a lower pulling tool adjacent to each other of each of the plurality of underwater installation-type water-flow power generation units under the deep sea after installation thereof can be prevented, a mutual lateral shift of each of the underwater installation-type water-flow power generation units can be minimized (that is, a positional fluctuation of each of adjacent power generating devices is made less), and a collision between each of the plurality of underwater installation-type water-flow power generation units can be prevented, and even in the case of installation in a considerably deep sea of each of the plurality of underwater installation-type water-flow power generation units, each of the plurality of underwater installation-type water-flow power generation units can be installed under the sea simply, rapidly, and safely in the same state as the installation under the shallow sea so that a large power generation output can be obtained efficiently and stably by using an ocean current or a water flow which is natural energy.

### BACKGROUND

With regard to the underwater installation-type water-flow power generation system, Japanese Patent No. 5905984 discloses an underwater installation-type water-flow power generation system for which the applicant of this application was previously granted a patent, having a weight body fixed, i.e., installed on a bottom of a water area with a water flow of the sea or a river, a power generating device including a power generating device body arranged in a water flow area above the weight body in the water area and moored by the weight body through a mooring fixture, a diagonal plate frontage portion for water-flow inflow provided on a front part of the power generating device body, a variable blade type rotary impeller provided on a rear part of the power generating device body, and a power generator for obtaining a power generation output by using a rotary force of the variable blade type rotary impeller, a hollow tank incorporated in the variable blade type rotary impeller and generating buoyancy equal to a weight of the rear part from an intermediate part in a total weight of the power generating device body, and a buoyancy body floated so it is arranged in the water flow area above the power generating device body and applying a tension to the power generating device body through a pulling tool so that the diagonal plate frontage portion of the power generating device body is facing a certain direction facing a direction of the water flow at all times so that a force of buoyancy is applied in connection only to a range from a distal end portion of the diagonal plate frontage portion of the power generating device body to a front part from substantially an intermediate part of the power generating device body, and the underwater installation-type water-flow power generation system constituted by the weight body, the power generating device, the buoyancy body, the mooring fixture, and the pulling tool is distributed and arranged at a plurality of spots in the water area with a water flow of the sea or a river.

The installation of the plurality of underwater installation-type water-flow power generation systems under the sea is preferably in an area from about 500 to 2000 m in the deep sea area in relation with the ocean current in order to obtain more favorable power generation outputs.

However, when the underwater installation-type water-flow power generation system using the ocean current as illustrated in FIGS. 1 and 3 in Japanese Patent No. 5905984 is to be installed in a plurality of positions with a rapid ocean current or flow velocity at 50 to 100 m below sea level in a deep sea area of, 500 to 2000 m below sea level, for example, if the weight body on the sea bottom and the power generating device of the underwater installation-type water-flow power generation system are directly connected by a length of the wire, such as, for example, a wire rope, of approximately 500 to 2000 m.

As a result, when a plurality of the underwater installation-type water-flow power generation systems using the ocean current as described in Japanese Patent No. 5905984 is to be installed at positions with a rapid ocean current or flow velocity at 50 to 100 m below sea level, for example, in the deep sea area, i.e., approximately 500 to 2000 m under sea level. Thus, in the past, since the power generating device location may shift a large distance even with a small change in a flow of the ocean current, adjacent power generating devices collide or contact each other, tangling adjacent wires or a mutual lateral shifting or similar disruptive movement can occur between each of the power generating devices. Thus, installation of the plurality of underwater installation-type water-flow power generation units in the deep sea is extremely difficult, making obtaining stable power generation output problematic.

### SUMMARY OF INVENTION

The present invention is to provides an underwater installation-type water-flow power generation system constituted such that, even if a plurality of underwater installation-type water-flow power generation units each having a simple and inexpensive installation constitution is to be installed in a deep water area, mutual tangling of each of an upper pulling tool and a lower pulling tool adjacent to each other of each of the plurality of underwater installation-type water-flow power generation units under the deep sea after installation thereof can be prevented, a mutual lateral shift of each of the underwater installation-type water-flow power generation units can be minimized by reducing positional fluctuations of each of adjacent power generating devices, and associated collision between each of the plurality of underwater installation-type water-flow power generation units. Even in the case of installation in a considerably deep sea of each of the plurality of underwater installation-type water-flow power generation units, each of the plurality of underwater installation-type water-flow power generation units can be installed under the sea simply, rapidly, and safely in the same state as the installation under the shallow sea so that a large power generation output can be obtained efficiently and stably by using an ocean current or a water flow which is natural energy as described in the prior art of aforementioned Japanese Patent No. 5905984.

The underwater installation-type water-flow power generation system of the present invention has a major feature of including a weight body fixed, i.e., installed on a bottom of a deep water area, a long underwater connection body arranged in a water flow area above the weight body and connected to the weight body through a lower pulling tool, and a plurality of underwater installation-type water-flow power generation units connected to the underwater connection body through a plurality of upper pulling tools at an interval and obtaining a power generation output by a water flow in a water area with a water flow or an ocean current above the underwater connection body.

An advantageous effect according to the claimed invention such as recited in claim 1, providing a large power generation output by each of power generating devices by mooring each of the underwater installation-type water-flow power generation units arranged at a position in an ocean current area through an underwater connection body by a weight body fixed, i.e., installed on a sea bottom of a deep water area, even if underwater installation-type water-flow power generation systems are to be installed in the deep water area, can prevent or minimize mutual tangling of each of an upper pulling tool and a lower pulling tool adjacent to each other of each of the plurality of underwater installation-type water-flow power generation units under the deep sea after installation thereof and mutual lateral shifting of each of the underwater installation-type water-flow power generation units by reducing positional fluctuations of each of adjacent power generating devices and associated collision between each of the plurality of underwater installation-type water-flow power generation units. Even in the case of installation in a considerably deep sea of each of the plurality of underwater installation-type water-flow power generation units, such an underwater installation-type water-flow power generation system can be provided such that each of the plurality of underwater installation-type water-flow power generation units can be installed under the sea simply, rapidly, and safely in the same state as the installation under the shallow sea. The claimed invention can thus provide an efficient and stable large power generation output using an ocean current which is natural energy.

According to the invention described in claim 2, by having constitution basically similar to that of the invention described in the aforementioned claim 1, in a plurality of the underwater installation-type water-flow power generation units connected to the underwater connection body through a plurality of the upper pulling tools at an interval in a water area with a water flow or an ocean current above the underwater connection body, the underwater installation-type water-flow power generation unit being constituted by having a power generating device including a power generating device body, a diagonal plate frontage portion for water-flow inflow provided on a front part of the power generating device body, a variable blade type rotary impeller provided on a rear part of the power generating device body, and a power generator for obtaining a power generation output by using a rotary force of the variable blade type rotary impeller, a hollow tank incorporated in the variable blade type rotary impeller and generating buoyancy equal to a weight of the rear part from an intermediate part in a total weight of the power generating device body, and a buoyancy body floated so it is arranged in the water flow area above the power generating device body and applying a tension to the power generating device body through a pulling tool so that the diagonal plate frontage portion of the power generating device body is facing a certain direction facing a direction of the water flow at all times so that a force of buoyancy is applied in connection only to a range from a distal end portion of the diagonal plate frontage portion of the power generating device body to the front part from substantially an intermediate part of the power generating device body, and position control is executed so that the diagonal plate frontage portion is facing the certain direction facing the direction of the water flow at all times by a mutual action of the buoyancy balance on a rear part side from the intermediate part by the hollow tank and a tension applied to the front part of the power generating device body through the pulling tool by the buoyancy body and thus, the underwater installation-type water-flow power generation system which can exert the effect similar to that of the invention described in the aforementioned claim 1 and can also reduce an ocean flow energy loss by efficiently rotating the variable blade type rotary impeller in the same direction as the ocean flow flowing in through the diagonal plate frontage portion can be realized and provided.

According to the invention described in claims 1-3 by means of constitution that a material of the underwater connection body is selected from a synthetic resin material, an iron material with an outer part subjected to rustproofing treatment, an aluminum material, a copper alloy material, and a stainless material, and a shape thereof is selected from a lattice-shaped lengthy body using the synthetic resin material, a cylindrical rod-shaped lengthy body, a lengthy body having a shape of an aircraft wing, a honeycomb-shaped lengthy body, a hollow cylindrical rod-shaped body or a band-shaped body, an elliptic band-shaped body, and a cylindrical body, the underwater installation-type water-flow power generation system with the effect similar to that of the invention described in the aforementioned claim 1 or 2 exerted and the effect that water resistance of the underwater connection body is reduced also capable of being exerted can be realized and provided.

According to the invention described in claim 4, in the invention described in any one of the aforementioned claims 1 to 3, by constituting the underwater installation-type water-flow power generation unit such that it is installed at a position of 10 to 50 m below the water level, the underwater connection body is installed at a position of 10 to 150 m below that, and the weight body is installed on the sea bottom at 120 to 2200 m below the water level, the underwater installation-type water-flow power generation system which exerts the effect of the invention described in any one of claims 1 to 3 can be realized and provided.

### BRIEF DESCRIPTION OF THE DRAWINGS

FIG. 1 is a schematic configuration diagram illustrating entire constitution of an underwater installation-type water-flow power generation system according to an embodiment of the present invention.

FIG. 2 is a schematic perspective view illustrating an example of an underwater connection body in the underwater installation-type water-flow power generation system according to this embodiment.

FIG. 3 is a schematic perspective view illustrating another example of the underwater connection body in the underwater installation-type water-flow power generation system according to this embodiment.

FIG. 4 is a schematic perspective view illustrating a single-body constitution of an underwater installation-type water-flow power generation unit in the underwater installation-type water-flow power generation system according to this embodiment.

FIG. 5 is a schematic enlarged perspective view of the underwater installation-type water-flow power generation unit in the underwater installation-type water-flow power generation system according to this embodiment.

FIG. 6 is a schematic explanatory view illustrating a carrying state by a ship for carrying each element for constructing the underwater installation-type water-flow power generation system according to this embodiment.

### DETAILED DESCRIPTION OF THE INVENTION

The present invention provides an underwater installation-type water-flow power generation system preventing or minimizing mutual tangling of each of an upper pulling tool and a lower pulling tool adjacent to each other of each of the plurality of underwater installation-type water-flow power generation units under the deep sea after installation thereof, a mutual lateral shifting of each of the underwater installation-type water-flow power generation units and associated positional fluctuations of each of adjacent power generating devices, and collision between each of the plurality of underwater installation-type water-flow power generation units, even when installation is in a deep sea. Hence, each of the plurality of underwater installation-type water-flow power generation units can be installed under the deep sea simply, rapidly, and safely in the same state as the installation under the shallow sea. Thus, a large power generation output can be obtained efficiently and stably by using an ocean current or a water flow which is natural energy by means of constitution including a weight body fixed, i.e., installed on a bottom of a deep-water area, a long underwater connection body arranged in a water flow area or an ocean current area above the weight body and connected to the weight body through a lower pulling tool, and a plurality of underwater installation-type water-flow power generation units connected to the underwater connection body through a plurality of upper pulling tools at an interval, each having a power generating device including a power generating device body, a diagonal plate frontage portion for water-flow inflow provided on a front part of the power generating device body, a variable blade type rotary impeller provided on a rear part of the power generating device body, and a power generator for obtaining a power generation output by using a rotary force of the variable blade type rotary impeller, a hollow tank incorporated in the variable blade type rotary impeller and generating buoyancy equal to a weight of the rear part from an intermediate part in a total weight of the power generating device body, and a buoyancy body floated so it is arranged in the water flow area above the power generating device body and applying a tension to the power generating device body through a pulling tool so that the diagonal plate frontage portion of the power generating device body is facing a direction of the water flow at all times so that a force of buoyancy is applied in connection only to a range from a distal end portion of the diagonal plate frontage portion of the power generating device body to the front part from substantially an intermediate part of the power generating device body, and position control is executed so that the diagonal plate frontage portion is facing the direction of the water flow at all times by a mutual action of the buoyancy balance on a rear part side from the intermediate part by the hollow tank and a tension applied to the front part of the power generating device body through the pulling tool by the buoyancy body.

Hereinafter, an underwater installation-type water-flow power generation system according to an embodiment of the present invention will be described in detail by referring to the attached drawings.

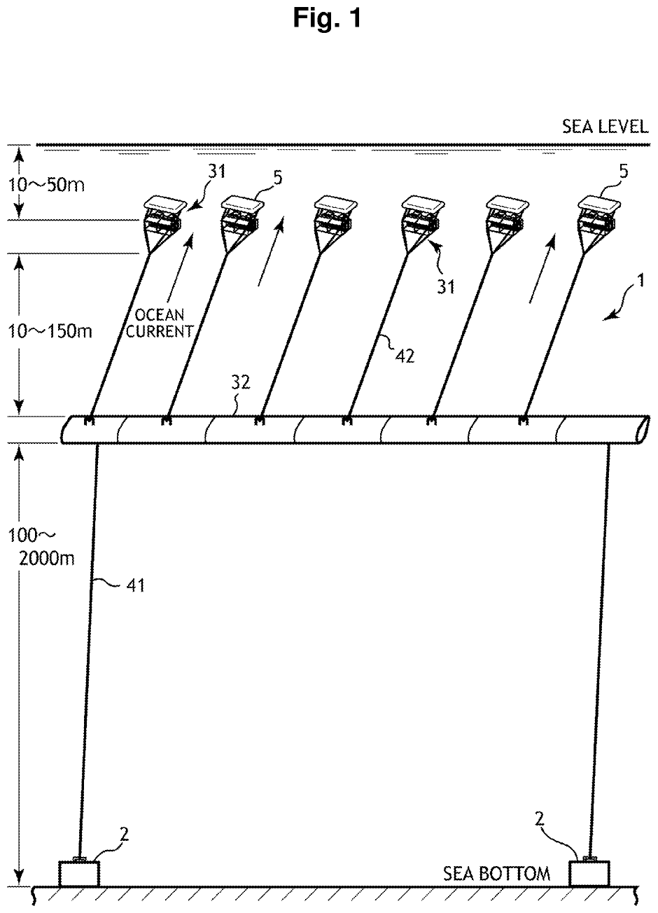

The underwater installation-type water-flow power generation system 1 according to this embodiment has, as illustrated in FIG. 1, a plurality of (6 units, for example) underwater installation-type water-flow power generation units 31 arranged at positions at a depth of 10 to 50 m (water area) below sea level (positions with an ocean current with a flow velocity of 1 to 3 m/s, for example) at a predetermined interval, two pieces, for example, of weight bodies 2 each having a weight of 5 t, for example, fixed/installed on a sea bottom of a deep water area such as at 150 to 2200 m from the sea level, for example, a (laterally long) lengthy underwater connection body 32 arranged at a position above the weight body 2 and at 10 to 150 m below the underwater installation-type water-flow power generation unit 31, lower pulling tools 41 each made of two ropes such as wire ropes for connecting the underwater connection body 32 and the two weight bodies 2, and upper pulling tools 42 each made of six ropes such as wire ropes for connecting each of the underwater installation-type water-flow generation units 31 and the underwater connection body 32.

For the lower pulling tool 41 and the upper pulling tool 42, a wire rope with specification that can endure tensile strength of approximately 100 t, for example, is employed.

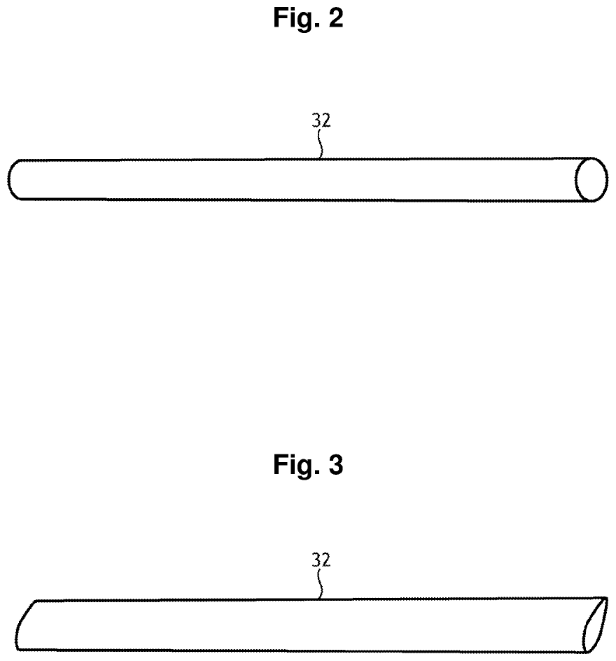

As the underwater connection body 32, other than the case illustrated in FIG. 1, a lengthy body made of a synthetic resin and having a round rod shape as illustrated in FIG. 2, a lengthy body made of a synthetic resin and having a shape of an aircraft wing (a shape which minimizes resistance against the ocean current as much as possible) as illustrated in FIG. 3, for example, and a laterally long lengthy body made of a synthetic resin and having a honeycomb shape, though not shown, and the like can be employed, and these shapes are determined from a viewpoint to minimize water resistance as much as possible.

For a material of the underwater connection body 32, a synthetic resin material, an iron material (with an outer part) subjected to rustproofing treatment, an aluminum material, a copper alloy material, a (hollow band-shaped) stainless material and the like can be employed.

Moreover, for the shape of the underwater connection body 32, a hollow round-rod shaped body or a band-shaped body, an elliptic band-shaped body, and a cylindrical body can be cited.

Though a lateral width of the underwater connection body 32 is determined by the number of a plurality of power generating devices to be installed, it is desirable that the lateral width thereof is approximately 10 to 200 m, a mutual interval between each of the plurality of power generating devices is approximately 5 to 50 m, a length of the upper pulling tool 42 connected above the underwater connection body 32 is 10 to 150 m, and a length of the lower pulling tool connected below the underwater connection body 32 is 100 to 2000 m, for example.

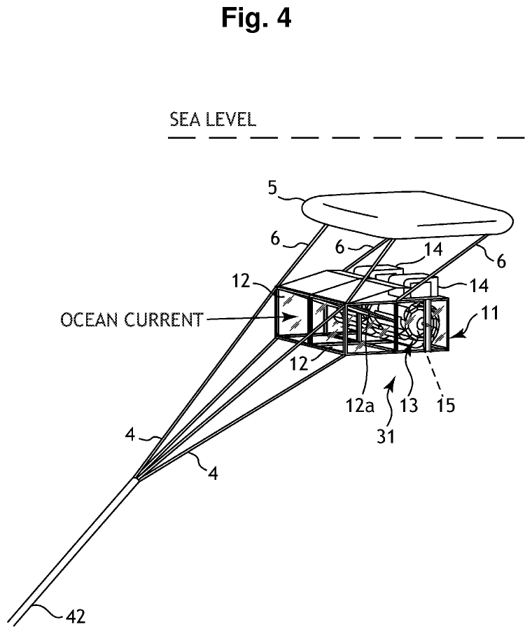

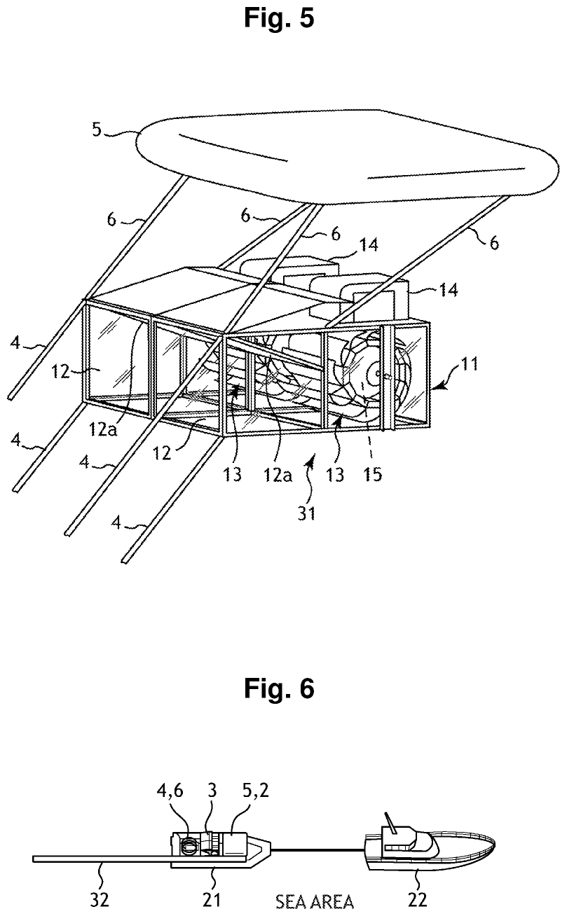

Subsequently, the underwater installation-type water-flow power generation unit 31 in this embodiment will be described in detail by referring to FIGS. 4 and 5.

The underwater installation-type water-flow power generation unit 31 has a power generating device 3 having a weight of 5 t and presenting a substantially cuboid shape, for example, and an under-the-sea floating type buoyancy body 5 floated and arranged in the ocean current area above this power generating device 3 and connected to the power generating device 3 by a pulling tool 6 such as a rope including a wire rope, a chain or the like.

Moreover, the power generating device 3 is connected to the upper pulling tool 42 by a mooring fixture 4 such as four ropes including wire ropes, chains or the like, for example.

For each of the mooring fixture 4 and the pulling tool 6, those with specification that can endure the tensile strength of approximately 100 t are used, for example.

The power generating device 3 includes a power generating device body 11 having a substantially cuboid cylindrical shape as illustrated in FIGS. 4 and 5.

With respect to this power generating device body 11, a diagonal plate frontage portion 12 for ocean-current inflow provided on a front part (on a side facing ocean current), a rotary drum-type variable blade type rotary impeller 13 rotated by the ocean current and provided on a rear flow side of this diagonal plate frontage portion 12, and a power generator 14 mounted on a rear part side of the power generating device body 11 and obtaining a power generation output by using a rotary force of the variable blade type rotary impeller 13 are arranged in a parallel structure of two rows in a direction orthogonal to an inflow direction of the ocean flow and are constituted so as to discharge the ocean current rearward from the rear part side of the variable blade type rotary impeller 13.

The diagonal plate frontage portion 12 is formed by a housing portion of the power generating device body 11 and a diagonal plate 12a with downward inclination as it goes from the front part of the power generating device body 11 toward the variable blade type rotary impeller 13.

Moreover, in the variable blade type rotary impeller 13, a hollow tank 15 generating buoyancy equal to a weight of a rear part from the intermediate part in the total weight of the power generating device under the sea is incorporated.

That is, the power generating device 3 according to this embodiment has a double structure including two units of the diagonal plate frontage portions 12, two units of the variable blade type rotary impellers 13 including the hollow tanks 15, and two units of the power generators 14, for example.

A connection structure between the upper pulling tool 42 and the power generating device body 11 by the mooring fixture 4 is made such that one end sides of the mooring fixture 4 in a state divided into four parts are connected to four corner parts on the both left and right end sides of the diagonal plate frontage portion 12 of the power generating device body 11, respectively, the other end portions of the mooring fixture 4 in the state divided into four parts are collected and integrated, and the integrated other end portions of the mooring fixture 4 are connected to the upper pulling tool 42, whereby the power generating device body 11 is moored by the weight body 2 through a lower pulling tool 43, the underwater connection body 32, the upper pulling tool 42, and the mooring fixture 4 so as not to be lost in the flow.

Subsequently, a connection structure between the power generating device body 11 and the buoyancy body 5 by the pulling tool 6 will be described.

In this embodiment, the buoyancy body 5 and the power generating device body 11 are connected by the pulling tool 6 so that an action of a tension by the buoyancy body 5 is applied only to a range from a distal end part of the diagonal plate frontage portion 12 of the front part of the power generating device body 11 to the front part from a substantially intermediate part (a substantially intermediate position in a flow direction of the ocean current) of the power generating device body 11.

More specifically, both lower corner parts of the front part (side facing the ocean current) of the buoyancy body 5 and both upper corner parts of the diagonal plate frontage portion 12 of the power generating device body 11 are connected by the two pulling tools 6, and both lower corner parts of the rear part of the buoyancy body 5 and the both side parts of the substantially intermediate part of the power generating device body 11 are connected by the two pulling tools 6.

That is, in more detail, the buoyancy body 5 and the power generating device body 11 have the structure in which the both lower corner parts of the front part (side facing the ocean current) of the buoyancy body 5 and the both upper corner parts of the diagonal plate frontage portion 12 of the power generating device body 11 are connected by the two pulling tools 6, and the both lower corner parts of the rear part of the buoyancy body 5 and the both side parts at a position in a range on the substantially center part or the front part from the center part (side facing the ocean current) of the power generating device body 11 are connected by the other two pulling tools 6.

As a result, by means of a mutual action of a buoyancy balance on the rear part side from the intermediate part of the power generating device 3 by the hollow tank 15 and a tension applied to the front part of the power generating device body 11 by the buoyancy body 5 through the pulling tool 6, the diagonal plate frontage portion 12 of the power generating device body 11 is configured to be positionally controlled so as to be facing a certain direction facing the direction of the ocean current at all times.

Though specific constitution of the variable blade type rotary impeller 13 is omitted, the constitutions of the variable blade type rotary impeller and the impeller in the turbine impeller type power generating device disclosed in Japanese Patent No. 5905984 and the Japanese Patent No. 5389082 held by the applicant of this application is employed for its basic constitution.

According to the underwater installation-type water-flow power generation system 1 according to the embodiment described above, the following operations and effects are exerted.

The underwater installation-type water-flow power generation system 1 according to this embodiment is constituted such that, even if a plurality of the underwater installation-type water-flow power generation units 1 each having a simple and inexpensive installation structure is to be installed in a deep water area, not only that tangling of the adjacent upper pulling tools 42 included on a lower part of each of the buoyancy bodies 5 of each of the plurality of underwater installation-type water-flow power generation units 1 under the deep sea after the installation thereof can be prevented, but also that mutual tangling of the lower pulling tools 41 connected to the lower parts thereof through the underwater connection body 32 can be prevented, and the mutual lateral shift between each of the underwater installation-type water-flow power generation units 1 can be minimized (that is, the positional fluctuation of each of the adjacent power generating devices can be made less) and a collision between each of the plurality of underwater installation-type water-flow power generation units 1 can be prevented, and even in the case of installation of each of plurality of underwater installation-type water-flow power generation units 1 in the considerably deep sea, each of the plurality of underwater installation-type water-flow power generation units 1 can be installed under the sea simply, rapidly, and safely in the same state as the installation under the shallow sea so that a large power generation output can be obtained efficiently and stably by using the ocean current or water flow which is natural energy.

That is, according to the constitution of the underwater installation-type water-flow power generation unit 1 including the illustrated underwater connection body 32, by means of the constitution in which the lower pulling tool 43 and the upper pulling tool 42 are connected through the underwater connection body 32, respectively, at positions above and below that, not only tangling of the adjacent upper pulling tools 42 but also mutual tangling of the lower pulling tools 41 connected to the lower part thereof through the underwater connection body 32 can be prevented, the mutual lateral shift between each of the underwater installation-type water-flow power generation units 1 can be minimized (that is, the positional fluctuation of each of the adjacent power generating devices can be made less), a collision between each of the plurality of underwater installation-type water-flow power generation units 1 is prevented, and even in the case of installation of each of plurality of underwater installation-type water-flow power generation units 1 in the considerably deep sea, each of the plurality of underwater installation-type water-flow power generation units 1 can be installed under the sea simply, rapidly, and safely in the same state as the installation under the shallow sea.

According to the underwater installation-type water-flow power generation system 1 according to the illustrated embodiment, each of the underwater installation-type water-flow power generation units 31 arranged through the lower pulling tool 43, the underwater connection body 32, the upper pulling tool 42, and the mooring fixture 4 at a position in the water area is moored by the weight body 2 fixed/installed on the sea bottom of the deep water area, and a large power generation output is obtained by each of the power generating devices 3.

Since the length of the upper pulling tool 42 between each of the underwater installation-type water-flow power generation units 31 and the underwater connection body 32 is relatively short as 50 to 100 m and thus, the positional fluctuation of the adjacent power generating devices 3 is less, a collision between the adjacent power generating devices 3 or tangling of the adjacent upper pulling tools 42 does not occur anymore, and a large power generation output can be obtained efficiently and in a stable state as a whole by using the ocean current which is natural energy.

Moreover, according to the underwater installation-type water-flow power generation unit 31 in the underwater installation-type water-flow power generation system 1 according to this embodiment, since position control is executed such that the diagonal plate frontage portion 12 of the power generating device body 11 is facing a certain direction facing a direction of the ocean current at all times, an ocean-current energy loss can be reduced by efficiently rotating the variable blade type rotary impeller 13 in the same direction as the flow of the sea water flowing in through this diagonal plate frontage portion 12.

Furthermore, in the variable blade type rotary impeller 13, since it has a variable blade structure in which the blades are folded other than a flow facing the ocean current, a rotation loss of the variable blade type rotary impeller 13 is minimized.

As a result, power generation efficiency of the power generating device 3 is increased as a whole, and a large power generation output can be obtained from the six units of power generators 14.

Furthermore, the underwater installation-type water-flow power generation system 1 according to this embodiment has a system constitution which is a combination of single structural bodies, and it also has a benefit of a low failure risk and easy maintenance and management.

Subsequently, one example of a construction method of the underwater installation-type water-flow power generation system 1 according to this embodiment will be described in brief by referring to each of the drawings including FIG. 6.

This construction method is performed such that the weight body 2, the power generating device 3 constituting the underwater installation-type water-flow power generation unit 31, the mooring fixture 4, the buoyancy body 5, the pulling tool 6, and moreover, the weight body 2, the underwater connection body 32, the upper pulling tool 42 and the lower pulling tool 41, though not illustrated in the figure, are placed on a ship 21 for transportation towed by a tugboat 22 and transported to an installation water area, the weight body 2, the power generating device 3, the buoyancy body 5, and the underwater connection body 32 are thrown into the sea of the installation water area, the weight body 2 is sunk to the sea bottom and fixed/installed, the power generating device 3 arranged in the water area is moored by the weight body 2 installed in the deep water area through the mooring fixture 4, the upper pulling tool 42, the underwater connection body 32, and the lower pulling tool 41, the buoyancy body 5 floated/arranged in the ocean current area above the power generating device 3 and the power generating device 3 are connected by the pulling tool 6 as described above, and a tension is applied to the power generating device 3 by the buoyancy body 5 through the pulling tool 6 so that the diagonal plate frontage portion 12 is facing a certain direction facing the direction of the ocean current at all times.

According to such construction method, since a large-sized heavy machine does not have to be used as a method for throwing the weight body 2, the power generating device 3, the buoyancy body 5, the underwater connection body 32 and the like into the sea, the underwater installation-type water-flow power generation system 1 can be constructed with an extremely low cost, and moreover, it can be installed extremely simply and inexpensively since a complicated installing work is not required and can be stably installed under the sea, and the underwater installation-type water-flow power generation system 1 with a low power generation cost can be constructed.

As described above, when power generation is performed by using the ocean current, according to this embodiment, a novel and inexpensive construction method of a novel ocean current power generation system of a type submerged under the sea in which no influence is given by bad weather, strength of a structure does not have to be too strong, an installation work cost can be low, and a power generation output can be obtained continuously for 24 hours, that is, an ideal ocean current power generation system under the sea can be realized.

In addition, the following points can be cited on the underwater installation-type water-flow power generation system 1 of this embodiment.

When the underwater installation-type water-flow power generation system 1 of this embodiment is compared with other methods using natural energy, since the sea water has a mass of approximately 1000 times of that of air, it has a large power generation amount as compared with wind power generation method with the same installation area and moreover, has a benefit of much larger installable place as compared with the wind power generation method.

Moreover, as compared with the solar power generation method, the wind power generation method and the like, since the ocean current energy is obtained at all times, a power generation system which can obtain stable power generation output at all times can be realized in a point that power generation is possible for 24 hours in 365 days without a rest.

### INDUSTRIAL APPLICABILITY

The underwater installation-type water-flow power generation system according to the present invention can be applied in a wide range such that, in addition to the aforementioned installation under the sea area, a large power generation amount is obtained by installation in water areas such as large rivers with a large depth and a stable water flow at all times.

### REFERENCE SIGNS LIST

1 Underwater installation-type water-flow power generation system
2 Weight body
3 Power generating device
4 Mooring fixture
5 Buoyancy body
6 Pulling tool
11 Power generating device body
12 Diagonal plate frontage portion
12 Diagonal plate
13 Variable blade type rotary impeller
14 Power generator
15 Hollow tank
21 Ship for transportation
22 Tugboat
31 Underwater installation-type water-flow power generation unit
32 Underwater connection body
41 Lower pulling tool
42 Upper pulling tool

1. An underwater installation-type water-flow power generation system comprising:
a weight body installed on a bottom of a deep-water area;
an elongate underwater connection body arranged in a water flow area above the weight body and connected to the weight body through a lower pulling tool; and
a plurality of underwater installation-type water-flow power generation units connected to the underwater connection body through a plurality of upper pulling tools at an interval in a water area with a water flow and an ocean current above the underwater connection body and obtaining a power generation output by a water flow.

1. An underwater installation-type water-flow power generation system comprising:
a weight body installed on a bottom of a deep-water area;
an elongate underwater connection body arranged in a water flow area above the weight body and connected to the weight body through a lower pulling tool; and
a plurality of underwater installation-type water-flow power generation units connected to the underwater connection body through a plurality of upper pulling tools at an interval in a water area with a water flow and an ocean current above the underwater connection body, wherein each of the plurality of underwater installation-type water-flow power generation units includes a power generating device including a power generating device body, a diagonal plate frontage portion for water-flow inflow provided on a front part of the power generating device body, a variable blade type rotary impeller provided on a rear part of the power generating device body, and a power generator for obtaining a power generation output by using a rotary force of the variable blade type rotary impeller, a hollow tank incorporated in the variable blade type rotary impeller and generating buoyancy equal to a weight of the rear part from an intermediate part in the total weight of the power generating device body, and a floated buoyancy body arranged in the water flow area above the power generating device body and applying a tension to the power generating device body through a pulling tool so that the diagonal plate frontage portion of the power generating device body is facing a certain direction facing a direction of the water flow at all times so that a force of buoyancy is applied in connection only to a range from a distal end portion of the diagonal plate frontage portion of the power generating device body to a front part from substantially an intermediate part of the power generating device body, and position control is executed so that the diagonal plate frontage portion is facing the certain direction facing a direction of the water flow at all times by a mutual action of the buoyancy balance on a rear part side from the intermediate part by the hollow tank and a tension applied to the front part of the power generating device body through the pulling tool by the buoyancy body.

3. The underwater installation-type water-flow power generation system according to claim 1, wherein
the underwater connection body includes a material selected from a synthetic resin, an iron with an outer part subjected to rustproofing treatment, an aluminum, a copper alloy, and a stainless steel, and wherein the underwater connection body has a configuration is selected from an elongate lattice using the synthetic resin, an elongate cylindrical rod, an elongate aircraft wing, an elongate honeycomb, a hollow rod, a band, an elliptic band, and a cylinder.

4. The underwater installation-type water-flow power generation system according to claim 1, wherein
the underwater installation-type water-flow power generation unit is installed at a position of 10 to 50 m below the water level, the underwater connection body is installed at a position spaced 10 to 150 m below that the water-flow power generation unit, and the weight body is installed on the sea bottom at 150 to 2200 m below the water level.

5. The underwater installation-type water-flow power generation system according to claim 2, wherein
the underwater connection body includes a material selected from a synthetic resin, an iron with an outer part subjected to rustproofing treatment, an aluminum, a copper alloy, and a stainless steel, and wherein the underwater connection body has a configuration selected from an elongate lattice using the synthetic resin, an elongate cylindrical rod, an elongate aircraft wing, an elongate honeycomb, a hollow rod, a band, an elliptic band, and a cylinder.

6. The underwater installation-type water-flow power generation system according to claim 2, wherein
the underwater installation-type water-flow power generation unit is installed at a position of 10 to 50 m below the water level, the underwater connection body is installed at a position spaced 10 to 150 m below the water-flow power generation unit, and the weight body is installed on the sea bottom at 150 to 2200 m below the water level.

7. The underwater installation-type water-flow power generation system according to claim 2, wherein
the underwater connection body includes a material selected from a synthetic resin, an iron with an outer part subjected to rustproofing treatment, an aluminum, a copper alloy, and a stainless steel, and wherein the underwater connection body has a configuration selected from an elongate lattice using the synthetic resin, an elongate cylindrical rod, an elongate aircraft wing, an elongate honeycomb, a hollow rod, a band, an elliptic band, and a cylinder; and
wherein the underwater installation-type water-flow power generation unit is installed at a position of 10 to 50 m below the water level, the underwater connection body is installed at a position spaced 10 to 150 m below the water-flow power generation unit, and the weight body is installed on the sea bottom at 150 to 2200 m below the water level.

8. The underwater installation-type water-flow power generation system according to claim 3, wherein
the underwater installation-type water-flow power generation unit is installed at a position of 10 to 50 m below the water level, the underwater connection body is installed at a position spaced 10 to 150 m below the water-flow power generation unit, and the weight body is installed on the sea bottom at 150 to 2200 m below the water level.
